(19) United States
(12) Patent Application Publication
(10) Pub. No.: US 2023/0221259 A1
(43) Pub. Date: Jul. 13, 2023

(54) DEVICE FOR CHEMILUMINESCENCE ANALYSIS

(71) Applicant: Analytik Jena GmbH, Jena (DE)

(72) Inventors: Stefan Hanitsch, Ilmenau (DE); Meike Hofmann, Ilmenau (DE)

(21) Appl. No.: 17/998,207

(22) PCT Filed: Apr. 19, 2021
(86) PCT No.: PCT/EP2021/060048

§ 371 Date: Nov. 8, 2022

(30) Foreign Application Priority Data
May 8, 2020 (DE) 10 2020 112 570.4

(51) Int. Cl. G01N 21/76

(52) U.S. Cl. CPC G01N 21/766; G01N 2201/063

(57) ABSTRACT

A device for chemiluminescence analysis includes: a reaction chamber; a first inlet opening for introducing a sample gas into the reaction chamber via a first supply line; a second inlet opening for introducing a reaction gas into the reaction chamber via a second supply line; an outlet opening for discharging a mixture of the sample gas and the reaction gas out of the reaction chamber via an outlet line; a mixer unit in which the sample gas and the reaction gas are mixed; and a sensor unit for detecting chemiluminescent radiation in the reaction chamber, wherein the mixer unit is arranged in a first end region of the reaction chamber, and the sensor unit is arranged in a second end region of the reaction chamber opposite the first end region. An elemental analyzer including the device is also disclosed.

The present invention relates to a device for chemiluminescence analysis, and to an elemental analyzer for elemental analysis of a sample, comprising a device according to the invention.

In chemiluminescence, electromagnetic radiation is emitted by a chemical reaction. A long-known application of chemiluminescence analysis is the detection of nitrogen oxides in ambient air. Nitrogen oxide (NO) thereby reacts with ozone (O₃) in a reaction chamber, by way of excited nitrogen dioxide while emitting a photon, to form nitrogen dioxide (NO₂). The reaction is accompanied by a comparatively weak luminous effect, especially in the infrared range, the detection of which normally requires a comparatively complex equipment cost.

The reactor chambers used for chemiluminescence analysis are usually made of glass or metal and are spherical, tubular, or cuboidal in shape. The reactor chambers are typically equipped with two supply lines and one outlet line. An infrared sensor, often in the form of a photomultiplier or a photodiode, especially a cooled photodiode, is coupled to the reactor chamber, for example via a sight glass. The coupling via a sight glass can disadvantageously lead to coupling losses upon signal acquisition, which are caused by reflections at a plurality of interfaces.

Depending on the flow rate, the pressure, and/or the arrangement of the supply lines along with the outlet line, a mixing is established in the reactor chamber via the supply lines, which mixing results in a defined distribution of the chemiluminescence. However, as a result of prevailing flow conditions, the mixing is disadvantageously often random. In addition, the connections for the supply lines and the discharge are often attached at an angle to the reactor chamber, such that gradients in the lateral direction can occur with regard to the degree of mixing. However, only a mean value of the infrared radiation can be detected via the sensor area of the infrared sensor. Thus, there is a disadvantageous dependence of the measurement on the prevailing flow conditions. In addition, signal drift and unwanted noise may occur.

Based on the cited disadvantages, the present invention is based on the object of improving the measurement accuracy of devices for chemiluminescence analysis.

This object is achieved by the device according to claim 1 and by the elemental analyzer according to claim 14.

With regard to the device, the object is achieved by a device for chemiluminescence analysis, comprising: a reactor chamber; a first inlet opening for introducing a sample gas into the reactor chamber by means of a first supply line; a second inlet opening for introducing a reaction gas into the reactor chamber by means of a second supply line; an outlet opening for discharging a mixture of the sample gas and the reaction gas out of the reactor chamber by means of an outlet line; and a sensor unit for detecting chemiluminescence radiation, especially in the form of infrared radiation, in the reactor chamber. According to the invention, the device comprises a mixer unit in which the sample gas and the reaction gas are mixed. The mixer unit is arranged in a first end region of the reactor chamber, and the sensor unit is arranged in a second end region of the reactor chamber, opposite the first end region.

The sensor unit and the mixer unit are preferably arranged along a longitudinal axis through the reaction chamber. Measurement inaccuracies due to gradients within the reactor chamber with regard to the degree of mixing are hereby markedly reduced or avoided. The measurement signal is less susceptible to fluctuations in the flow rate, and therefore less susceptible to drift and/or noise.

The mixer unit additionally has the effect of a markedly more uniform course of the reaction in the reaction chamber. This increases the quantum yield, and consequently therewith leads to a higher sensitivity in the measurement of chemiluminescence. Alternatively, the instrumental setup can also be simplified while maintaining the same sensitivity. In this context, it is conceivable both to reduce the size of the equipment setup and to miniaturize it.

With regard to miniaturization, it is to be noted that, with increasing reduction of the dimensions of the device, the Reynolds number of the flowing gases decreases, which hinders the mixing of the reactants in standard devices for chemiluminescence analysis, especially devices with a tubular reactor chamber. In addition, depending on the selected arrangement, the inlets and the outlet, along with the corresponding connections for supply and outlet lines, may contribute to the total volume, which can likewise be disadvantageous to miniaturization. By using a mixer unit according to the invention, these disadvantages can be overcome such that the achievement according to the invention enables a miniaturization of a corresponding device. Accordingly, via the present invention it is advantageously possible to provide a portable instrument for chemiluminescence analysis. A portable instrument is of great advantage in the field of environmental analysis, for example.

One embodiment includes that the sensor unit has an image intensifier. In addition, a photomultiplier or photodiode can be used. Via the image intensifier, a shift in the wavelength range can be realized and the signal intensity can be improved. The cooling of the sensor unit can thereby advantageously be dispensed with.

With regard to the mixer unit, it is advantageous if the mixer unit has a plurality of alternating first and second inlet openings for the inlet of the sample gas and the reaction gas into the reactor chamber, wherein the first inlet openings are respectively fluidically connected to the first supply line, and the second inlet openings are respectively fluidically connected to the second supply line. In this embodiment, the mixer unit is designed essentially in the form of a shower head or mixing nozzle. The first and second inlet openings are advantageously arranged at least partially alternating. By using a plurality of first and second inlet openings, an especially uniform introduction of the reactants into the reactor chamber can be ensured. Another advantage is that a high degree of mixing of the sample gas and the reaction gas in the reactor chamber can already be achieved at comparatively low pressures.

In this respect, it is advantageous if the mixer unit is made of low-temperature cofired ceramics (LTCC). This is especially advantageous given small dimensions of the device, i.e., if miniaturization is the goal.

In a further embodiment, the device comprises a temperature control unit that is designed and/or arranged to control the sample gas and/or the reaction gas before it arrives in the reactor chamber and/or the mixer unit. This enables the adjustment of the reaction kinetics even before the reactants are introduced into the reactor chamber.

In a further embodiment, the device comprises a reflection unit that is arranged in the first end region of the reactor chamber. The reflection unit is, for example, a mirror, especially a perforated mirror. By means of the reflection unit, parts of emitted light that are not directed towards the sensor unit can also be steered towards the sensor unit. This measure increases the achievable quantum yield, and thus increases sensitivity.

In a further embodiment, the reactor chamber is at least partially made of a reflective material, or at least partially coated with a reflective material, especially in the region of an inner wall. This can thereby be both a diffusely or a directionally reflective material. This measure also increases the achievable quantum yield.

In a further embodiment of the device, the reactor chamber comprises a window in the second end region, wherein the sensor unit is arranged outside the reactor chamber in the region of the window.

In this context, it is advantageous if the device comprises an optical element, especially a converging lens or a total reflection element, for coupling the chemiluminescence radiation into the sensor unit, which optical element is arranged between the window and the sensor unit.

It is also advantageous if an immersion medium is arranged between the optical element and a sensor of the sensor unit. The immersion medium has the effect of a reduction of coupling losses between the optical element and the sensor unit.

In yet another embodiment of the device, the outlet opening is designed to be annular and is fluidically connected to the outlet line, wherein the outlet opening is arranged in the second end region; especially, the outlet opening is arranged around the window. Due to the annular embodiment of the outlet opening, the respective exhaust gas can be extracted concentrically, especially concentrically around the window at which the sensor unit is arranged. This uniform gas outflow has the effect that a gradient of luminous intensity across the surface of the sensor unit is as small as possible.

It is advantageous if the reactor chamber is designed in the form of a hollow cylinder. However, numerous other geometric shapes, such as the shape of a cuboid, are also conceivable and fall within the scope of the present invention.

The reactor chamber advantageously has a larger diameter and/or a larger cross-sectional area than the sensor unit. In this event, the luminescence radiation can also enter laterally into the sensor unit. This effect is further enhanced by the use of an optical element.

With respect to the diameters and cross-sectional areas of the reactor chamber and sensor unit, it is also to be noted that the cross-sectional areas and diameters of the active areas of a sensor unit can differ from the cross-sectional area and diameter of the sensor unit and/or from the cross-sectional area and diameter of the reactor chamber. For example, the active areas of the sensor unit may be square in shape, whereas a housing of the sensor unit is round. In principle, the respective ratios of the diameters and/or cross-sectional areas must be taken into account.

The object underlying the invention is further achieved by an elemental analyzer for elemental analysis of a sample comprising a device according to the invention according to at least one of the described embodiments.

With regard to the elemental analyzer, it is advantageous if it is a device for analyzing total nitrogen in a sample, nitric oxide, or nitrogen dioxide.

The invention and its advantageous embodiments are explained in further detail using the following Figure.

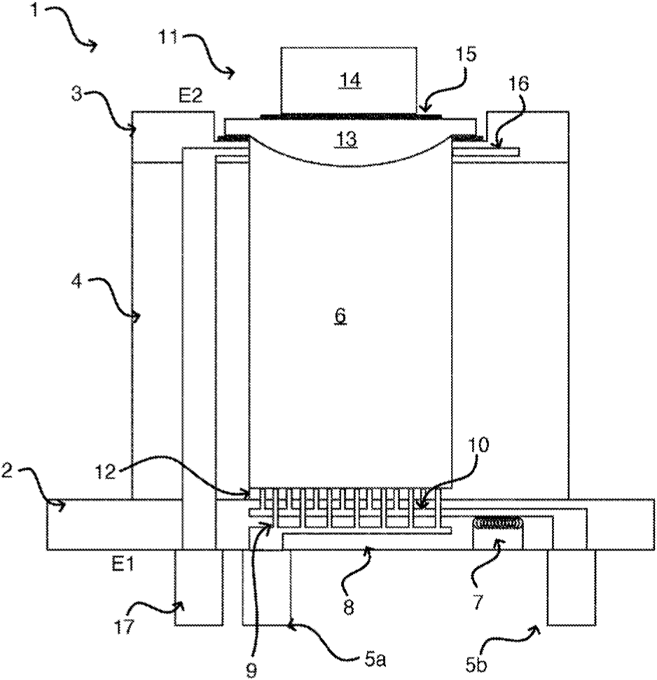

FIG. 1 shows an advantageous embodiment for a device 1 according to the invention. The device 1 has a lower base plate 2 and an upper base plate 3 which may respectively be designed in the form of a ceramic plate, for example. The first base plate 2 is located in a first end region E1 of the device, and the second base plate 3 is located in a second end region E2 of the device 1. A spacer 4 is arranged between the two base plates 2, 3. For the shown embodiment, the reactor chamber 6 is formed in the shape of a through-hole through the spacer 4.

The gaseous reactants, the sample gas, and the reaction gas are introduced into the reactor chamber 6 via fluidic connections for a first 5a and a second supply line 5b, which are arranged in the region of the lower base plate 2. Optionally, a temperature control unit 7 can be provided by means of which the sample gas and/or the reaction gas can be controlled, especially, before the gas(es) arrive(s) in the reactor chamber 6. For the embodiment shown here, the temperature control unit 7 is arranged in the region of the lower base plate 2 by way of example and comprises a resistance element.

The reactants arrive in the reactor chamber 6 via the mixer unit 8. The mixer unit 8 is designed in the form of a spray head and comprises a plurality of first 9 and second inlet openings 10, which here are arranged alternating and are fluidically connected to the first 5a or second supply line 5b, respectively. By using the mixer unit 8, a uniform introduction of the reaction gas and the sample gas into the reactor chamber 6 can be ensured.

Upon contact, a spontaneous reaction of the sample gas and the reaction gas takes place, wherein chemiluminescence occurs. The intensity of this luminous phenomenon serves as a measure of the concentration of one of the reactants.

In order to increase the sensitivity of the measurement, it is expedient to direct as much light as possible to the sensor unit 11 arranged in the second end region E2. For this purpose, a reflection unit 12, for example in the form of a perforated mirror, is arranged as an optional component in the first end region E1. Likewise, the surfaces of the reactor chamber 6 may optionally be made of a reflective material or coated with a reflective material.

For the shown embodiment, the sensor unit 11 comprises an optical element 13 and a sensor 14, wherein an immersion medium 15 is arranged between the optical element 13 and the sensor 14, which reduces coupling losses at the interfaces between the sensor 14 and the optical element. The sensor 14 can, for example, be a photomultiplier or a photodiode. The optical element 13 is, for example, a converging lens.

The products, excess reactants, and carrier gases are discharged as exhaust gas out of the reactor chamber 6 via a second hole in the spacer, via a concentrically circling exhaust channel (m) in the upper plate. The fluidic and electrical connections can be executed in such a way that they are restricted to the lower plate 2.

The outlet opening 16 is likewise located in the second end region E2. For the embodiment shown here, it is designed to be annular and fluidically connected to the outlet line 17. Through the outlet opening 16, products, excess reactants, as well as carrier gases pass out of the reactor chamber 6 as exhaust gases via the outlet line 17. For the shown embodiment for a device 1 according to the invention, all fluidic and electrical connections are advantageously arranged in the region of the lower base plate 2 and are accordingly designed in such a way that they are restricted to the lower base plate 2. This greatly simplifies the design of the device 1.

It is to be noted that the present invention is by no means limited to the embodiment shown here. This is to be understood merely as an example. Other variants may comprise other embodiments mentioned in the description. Numerous further possible structures of the reaction chamber 6 are also conceivable and likewise fall within the scope of the present invention. A preferred application for a device 1 according to the invention consists of the use in an elemental analyzer, not separately shown here. A further preferred application is to provide a portable instrument for chemiluminescence analysis which is usable especially in the field of environmental analysis.

Reference Signs

| | |
|---|---|
| 1 | Device |
| 2 | Lower base plate |
| 3 | Upper base plate |
| 4 | Spacer |
| 5 | a,b First, second supply line |
| 6 | Reactor chamber |
| 7 | Temperature control unit |
| 8 | Mixer unit |
| 9 | First inlet openings |
| 10 | Second inlet openings |
| 11 | Sensor unit |
| 12 | Reflection unit |
| 13 | Optical element |
| 14 | Sensor |
| 15 | Immersion medium |
| 16 | Outlet opening |
| 17 | Outlet line |
| E1 | First end region |
| E2 | Second end region |

1-15. (canceled)

16. A device for chemiluminescence analysis, the device comprising:
a reaction chamber having a first end region and a second end region opposite the first end region;
a first inlet opening adapted to enable introducing a sample gas into the reactor chamber via a first supply line;
a second inlet opening adapted to enable introducing a reaction gas into the reactor chamber via a second supply line,
an outlet opening adapted to enable discharging a mixture of the sample gas and the reaction gas from the reactor chamber via an outlet line;
a mixer unit configured to facilitate mixing of the sample gas and the reaction gas, the mixer unit arranged in the first end region of the reactor chamber; and
a sensor unit configured to detect chemiluminescence radiation in the reactor chamber, the sensor unit arranged in the second end region of the reactor chamber.

17. The device of claim 16, wherein the sensor unit includes an image intensifier.

18. The device of claim 16, wherein the mixer unit includes a plurality of alternating first and second inlet openings configured to introduce the sample gas and the reaction gas into the reactor chamber,
wherein the plurality of first inlet openings are each fluidically connected to the first supply line, and the plurality of second inlet openings are each fluidically connected to the second supply line.

19. The device of claim 18, wherein the mixer unit comprises a low-temperature cofired ceramic.

20. The device of claim 16, further comprising a temperature control unit configured and/or arranged to control a temperature of the sample gas and/or a temperature of the reaction gas before either is supplied to the mixer unit and/or introduced into the reactor chamber.

21. The device of claim 16, further comprising a reflection unit disposed in the first end region of the reactor chamber.

22. The device of claim 16, wherein the reactor chamber comprises a reflective material, or is at least partially coated with a reflective material on an area of an inner wall of the reactor chamber.

23. The device of claim 16, wherein the reactor chamber comprises a window in the second end region, and wherein the sensor unit is arranged outside the reactor chamber in a region about the window.

24. The device of claim 23, wherein the outlet opening is adapted to be annular and is fluidically connected to the outlet line, and wherein the outlet opening is arranged around the window.

25. The device of claim 23, further comprising an optical element configured to couple the chemiluminescence radiation into the sensor unit, wherein the optical element is arranged between the window and the sensor unit.

26. The device of claim 25, wherein the optical element is a converging lens or a total reflection element.

27. The device of claim 25, wherein an immersion medium is arranged between the optical element and a sensor of the sensor unit.

28. The device of claim 16, wherein the outlet opening is adapted to be annular and is fluidically connected to the outlet line, and wherein the outlet opening is disposed in the second end region.

29. The device of claim 16, wherein the reactor chamber is configured as a hollow cylinder.

30. The device of claim 16, wherein a diameter of the reactor chamber is greater than a diameter of the sensor unit.

31. An elemental analyzer for elemental analysis of a sample, the elemental analyzer comprising a device according to claim 16.

32. The elemental analyzer of claim 31, wherein the device is configured to analyze total nitrogen in a sample, nitrogen oxide, or nitrogen dioxide.
